(19) United States
(12) Patent Application Publication
(10) Pub. No.: US 2005/0060757 A1
(43) Pub. Date: Mar. 17, 2005

(54) Apparatus and method of broadcast service for transporting scene information

(76) Inventor: Jong Yeul Suh, Seoul (KR)

Correspondence Address: BIRCH STEWART KOLASCH & BIRCH, PO BOX 747, FALLS CHURCH, VA, 22040-0747, US

(21) Appl. No.: 10/941,972

(22) Filed: Sep. 16, 2004

(30) Foreign Application Priority Data
Sep. 17, 2003 (KR) 10-2003-0064428

(51) Int. Cl. H04N 7/025; H04N 7/16; H04N 7/10

(52) U.S. Cl. 725/135; 725/136; 725/32

(57) ABSTRACT

An apparatus and method of broadcast service for more accurately and quickly performing predetermined trick play functions (such as, skip, and skim) by using a scene information that is transported with a broadcast stream in real time or non-real time mode.

### BACKGROUND OF THE INVENTION

1. Field of the Invention

The present invention relates to an apparatus and method of broadcast service for transporting information about a broadcast program to a broadcast display.

2. Discussion of the Background Art

With the growth of popularity and recent technical advances in ground wave signal receivers, more complicated and diversified products have been released. The center of interest among them is a recently developed personal video recorder (or PVR).

The PVR is a consumer electronics device that records information (e.g., broadcast programs) to a hard disk Unlike a traditional VCR that records an image signal to a magnetic tape, the PVR is a digital recorder with a new concept, recording and replaying information in digital format.

Without the use of a VCR, the PVR is capable of recording TV broadcast programs to a set-top box or through a hard disk drive built in the main body of a television set for a certain amount of time according to its given capacity. For this reason, the PVR is regarded as a next generation recorder.

When a viewer selects a channel, the PVR automatically records live TV to a hard disk drive (HDD) in digital format, and replays at the same time.

Therefore, if the viewer presses the stop button and then the replay button, the recorded broadcast is replayed from the stopped point.

Also, the PVR allows the viewer to watch the live TV again (such as pausing live TV and replaying interesting scenes), replay the program in a slow motion, skip the boring part like advertising, and search interesting scenes and edit.

A broadcast display comprising a PVR is a device that records a digital broadcast to a recording medium, namely a hard disk This makes the ‘time shifting’ feature (traditionally done by a VCR) more convenient, and allows for ‘trick modes’, for example, instant replay of interesting scenes in the live TV, skipping scenes, skimming, high light and browsing.

Most of all, the best advantages of the PVR are that the viewer is able to record high definition (HD), high-picture digital broadcasts to a hard disk and watch them at anytime, and there are many kinds of additional services besides recording.

Particularly, those additional services implemented in the PVR provide an access to digital broadcast programs recorded to the PVR/DTV from diverse aspects.

For instance, high light, skip and skimming functions of the PVR enable the viewer to search or browse a vast amount of video data within a short time.

In recent years, a new method has been developed for automatically extracting semantic data about a program by spontaneously analyzing a video stream.

The semantic data is utilized for providing a non-linear search or browsing function on the basis of the program contents.

That is to say, a program is divided into a semantic unit called scene, and each scene is treated as a replay unit. The above-described trick modes (or trick play functions) are provided on a scene-by-scene basis.

By using scene information, the viewer is able to use the skip function to go directly to the start point of the next scene during the time shift or replay.

The scene information can also be used for implementing the skim function, one of high light functions of the trick modes that replays only a certain part of each scene.

A related art apparatus and method for providing high light function will now be described with reference to FIG. 1.

FIG. 1 is a schematic block diagram of components of a related art PVR that provides information for implementing predetermined functions among broadcast services.

As shown in FIG. 1, the PVR includes an IR (Infrared rays) receiver 100, a controller 110, a memory 120, a tuner 130, a DeMux 150, an output unit 160, an IDE interface 170, a storage HDD 180, and a high light information generation block 190.

The IR receiver 100 receives a remote control (not shown) code that is selected by a viewer, and transmits it to the controller 110.

The controller 110 analyzes the remote control code transmitted from the IR receiver 100, and transmits the remote control code analysis to a corresponding device.

For example, if the remote control code analysis turns out to be a channel change request command, the controller 110 transmits the channel change request command to the tuner 130. Similarly, if the remote control code analysis turns out to be a program record command, the HDD 180 stores the requested program.

The memory 120 includes a flash ROM for saving software such as operating system, and a DRAM for saving virtual scenes in bitmap format that are outputable on the output unit.

The tuner 130, under the control of the controller 110, receives a broadcast stream of a channel of a selected station.

The DeMux 140 parses various information of audio, video and other data that are muxed broadcast streams provided from the tuner.

The decoder 150 decodes the audio, video signals and the data signals parsed in the DeMux 140 to process the signals to be visible and audible to the viewer.

The IDE (Integrated Drive Electronics) interface 170 receives a TP Transport) data from the decoder 150 for recording, and transmits it to the HDD 180.

If a replay request command is issued, the controller 110 transmits the data recorded to the HDD 180 to the decoder 150.

The HDD 180 records the TP data transmitted from the IDE interface 170. In other words, the HDD 180 records a broadcast stream of a program the viewer chose to record.

The high light generation block 190 includes a transition detector 102 for detecting transition of a video scene, a interval information amount estimator 194 for estimating the amount of information of an interval by using the detected transition information, and a moving image generator 196 for generating a high light by considering the estimated amount of the information of the interval and the length of the high light.

The transition detector 192 detects a transition in the recorded digital video. A frame with a transition becomes the start point of each scene. Thusly recorded digital video is divided into scenes.

When the transition detecting operation is completed, the transition detector 192 transmits to the interval information amount estimator 194 a list of frames composing each scene.

The interval information amount estimator 194 estimates significance of each scene on the basis of the bit, and sends the amount of information of each interval to the moving image generator 196.

The moving image generator 196 determines an interval for generating high light moving images according to the amount the viewer inputted or the default logic.

However, to implement the high light function in the related art broadcast display, it is absolutely required to detect a boundary or a transition of scenes with respect to a broadcast stream being received. The transition detection is accomplished by the complex video data analysis methods with the aid of hardware and software Systems on the broadcast program, so there is a need to develop an easier way to detect the transition.

Improving the accuracy of the transition detection also requires a highly complex process.

Because broadcast programs of different genre have their own video properties regardless of techniques being used, their transition detection algorithms are different as well. Thus, the accuracy thereof will always remain unsatisfactory.

In practice, it is also impossible to recognize a program of interest and accurately divide the program into scenes for automatically extracting a meaningful high light to the viewer on the basis of the contents.

### SUMMARY OF THE INVENTION

An object of the invention is to solve at least the above problems and/or disadvantages and to provide at least the advantages described hereinafter.

Accordingly, one object of the present invention is to solve the foregoing problems by providing an apparatus and method of broadcast service for providing a viewer with a more accurate scene information that is transported with/without a broadcast stream, in which the scene information about a broadcast program is produced by a broadcast information provider (e.g., a TV station/scene information service provider).

Another object of the present invention is to control a PVR and a DTV of a broadcast display to more effectively perform a trick play, which is a predetermined separate function, using scene information being transported from a broadcast information provider.

The foregoing and other objects and advantages are realized by providing an apparatus of broadcast service for use in a broadcast system comprised of a broadcast information provider for outputting a broadcast stream and/or scene information; and a broadcast display for receiving and displaying the outputted broadcast stream, wherein when a broadcast stream including a plurality of scenes is transported to the broadcast display, a scene information corresponding to each scene is transported with the broadcast stream or separately.

Another aspect of the invention provides a method of broadcast service, including the steps of: producing a scene information on each scene; transporting to a broadcast display the scene information and a broadcast stream in real time or non-real time mode; and based on the transported scene information, performing a predetermined function on the broadcast stream.

According to the present invention, a station or a third party service provider produces split scene information and transmits them in real time or non-real time mode. Then a broadcast display receives the scene information, and implements application services for a recorded broadcast program more effectively.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram of components of a related art PVR that provides information for implementing predetermined functions among broadcast services;

FIG. 2a is a block diagram of an apparatus of broadcast service illustrating that a broadcast information provider according to a preferred embodiment of the present invention provides broadcast information to a user device (or a broadcast display);

FIG. 2b is a block diagram illustrating that a broadcast information provider including a scene information service provider according to another preferred embodiment of the present invention provides broadcast information to a broadcast display,

FIG. 3a is a schematic block diagram illustrating the structure of a PVR system according to a preferred embodiment of the present invention;

FIG. 3b is a block diagram illustrating part of components of a PVR system shown in FIG. 3a, including a DeMux, a decoder, a browsing controller, and a HDD uproad control unit;

FIG. 4 illustrates a composition of broadcast information transporting a broadcast stream with a scene information according to a preferred embodiment of the present invention;

FIG. 5a illustrates a composition of a scene information according to a preferred embodiment of the present invention, in which a broadcast stream is transported with the scene information;

FIG. 5b illustrates a composition of a scene information according to a preferred embodiment of the present invention, in which a broadcast stream is not transported with the scene information;

FIG. 6 is a flow chart describing a method for transporting scene information and a broadcast stream in real time or non-real time mode;

FIG. 7 is a flow chart describing a method for performing a trick play according to a preferred embodiment of the present invention;

FIG. 8a is a schematic diagram illustrating implementation of a scene skip function according to a preferred embodiment of the present invention;

FIG. 8b is a flow chart describing a skip operation;

FIG. 9a is a schematic diagram illustrating implementation of a scene skim function according to a preferred embodiment of the present invention; and

FIG. 9b is a flow chart describing a skim operation.

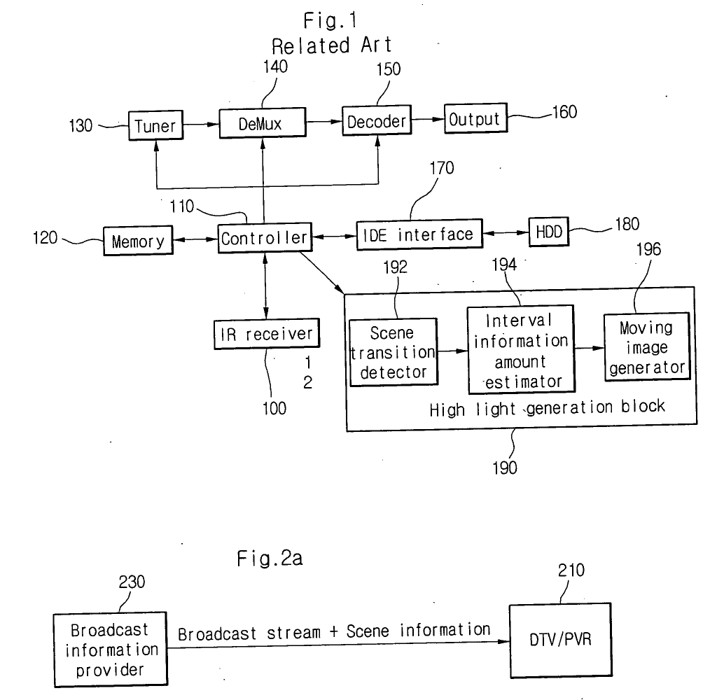

### DETAILED DESCRIPTION OF PREFERRED EMBODIMENTS

The following detailed description will present preferred embodiments of the invention in reference to the accompanying drawings.

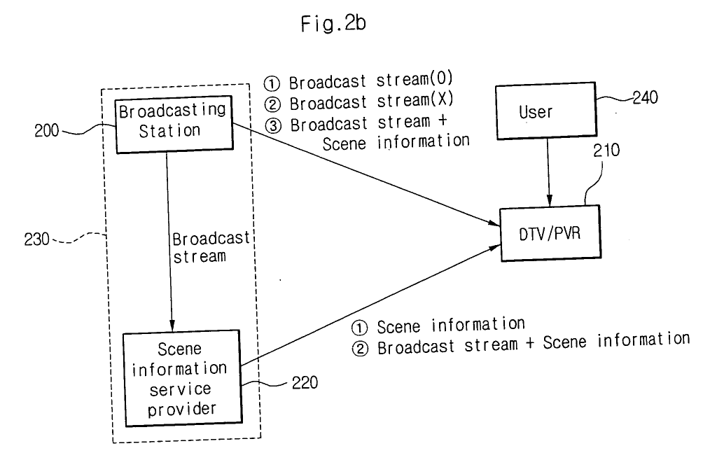

FIG. 2a is a block diagram illustrating that a broadcast information provider according to a preferred embodiment of the present invention provides broadcast information to a user device (or a broadcast display.

As shown in FIG. 2a, a broadcast information provider 230 including a TV station 200 produces scene information for each program, and transports the scene information with a broadcast stream to a broadcast display (DTV/PVR) 210.

If a trick play request command which is a predetermined, separate command, is issued by a user (or a viewer), the DTV/PVR 210 extracts from the scene information a start information thereof, a scene ID, a scene pointer, and a skim information, and by using the information, implements a trick play based on the scene information like the skimming.

In other words, the user implements a trick play including skim, skimming, non-linear replay, browsing, and search functions by using the scene information.

Because the station where a broadcast program is produced is directly involved in transporting the start point of each scene for a program of the user's interest, the user is provided with more accurate split scene information and its related additional functions.

Here, the scene information is first multiplexed with broadcast streams including a corresponding program's video, audio and additional data, and is transported later (please refer to FIG. 4).

The scene information can be transported to the user in real-time or non-real time mode.

FIG. 2b is a block diagram of an apparatus of broadcast service illustrating that a broadcast information provider 230 including a scene information service provider 220 according to another preferred embodiment of the present invention provides broadcast information to a broadcast display 210.

As shown in FIG. 2b, the broadcast information provider (a station/a scene information service provider) 230 includes a TV station 200 for transporting broadcast information (broadcast streams/scene information) or broadcast streams; and a scene information service provider 220 for automatically or semi-automatically splitting or dividing the broadcast stream transported from the station, and transporting the scene information to the broadcast display 210.

Also, there is a user 240 who is allowed to input a command whether to execute separate functions that are predetermined by the broadcast display 210.

There can be three types of broadcast services provided by the apparatus of FIG. 2b. For example, the apparatus transports only a broadcast stream, or does not transport broadcast information at all, or transport a scene information produced by the station 200, and a broadcast stream to the broadcast display 210.

Meanwhile, the scene information about a broadcast program can be produced by a third party such as the scene information service provider 220 besides the station, and is transported with a broadcast stream from the station in non-real time mode.

If the split scene information is transported by a third party service provider, it means that there is a subject transporting program contents of interest, and another subject transporting scene information.

That is, if the third party service provider transmitted a split scene information, it indicates two things: one is that the station will not provide the split scene information, and the other is that the third party service provider has already a corresponding program.

The third party service provider automatically/semi-automatically splits the program into scenes, and based on the contents it decides information and replay mode for each scene.

This type of service system can also be applied to the station if there is enough time before starting the production of contents such as a drama and before the drama actually starts running.

Even for live TV, the third party service provider is able to provide scene information at certain time intervals.

The interval here corresponds to the amount of time the third party service provider takes to analyze the broadcast stream in real time mode.

In the case of a drama that is usually pre-produced, the third party service provider can transport the broadcast stream and the scene information together.

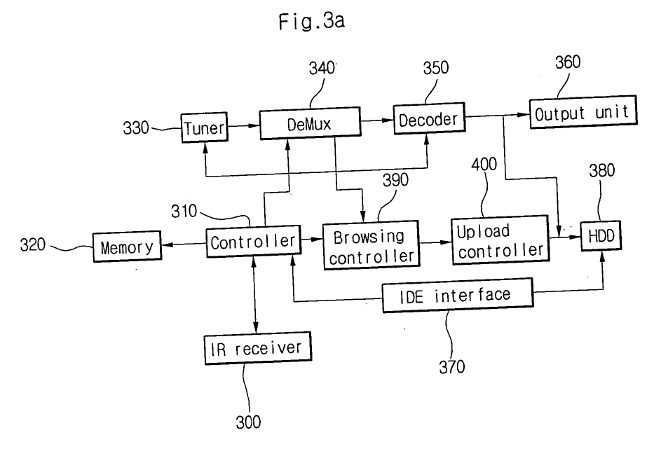

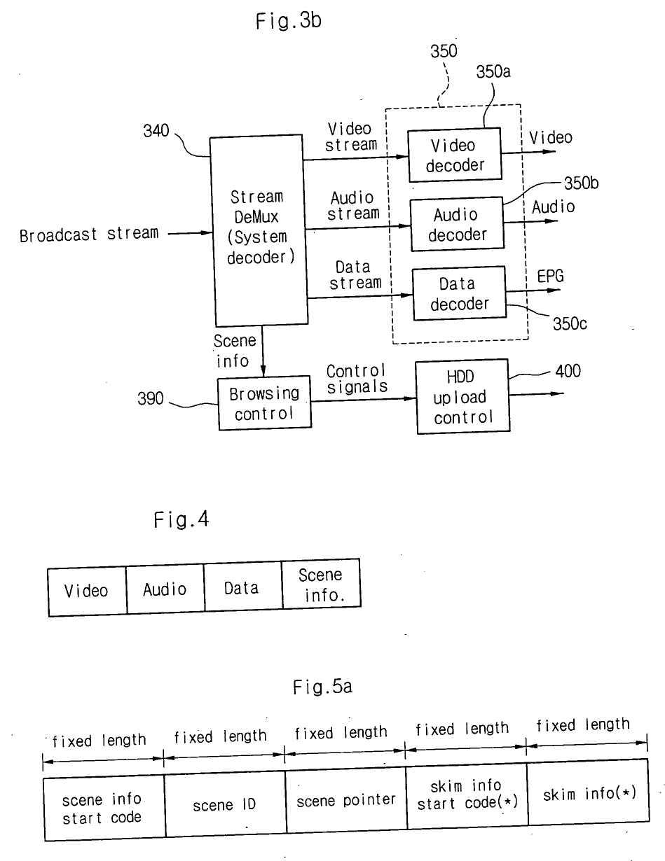

FIG. 3a is a schematic block diagram illustrating the structure of a PVR system according to a preferred embodiment of the present invention.

As shown in FIG. 3a, the PVR includes an IR receiver 300, a control unit 310, a memory 320, a tuner 330, a DeMux 340, a decoder 350, an output unit 360, an IDE interface 370, a storage (i.e., HDD) 380, a browsing controller 390, and an HDD upload controller 400.

The IR receiver 300 receives a remote control code that is selected by the user 240, and transmits it to the control unit 310.

The control unit 310 analyzes the remote control code transmitted from the IR receiver 300, and transmits the remote control code analysis to a corresponding device.

For example, if the remote control code analysis turns out to be a channel change request command, the control unit 310 transmits the channel change request command to the tuner 330. Similarly, if the remote control code analysis turns out to be a command for replaying data saved in the HDD 380, the control unit 310 issues a data replay command to the decoder 350.

The memory 320 includes a flash ROM for saving software such as operating system, and a DRAM for saving virtual scenes in bitmap format that are outputable on the output unit.

The tuner 330, under the control of the control unit 310, selects a station of the channel currently being watched.

The DeMux 340 parses various information such as audio, video, data and scene information which are multiplexed broadcast streams provided from the tuner 340.

Then the DeMux 340 transports the parsed audio, video and data to the decoder 350, and the scene information to the browsing control unit 390.

The decoder 350 decodes the audio, video signals and the data signals parsed in the DeMux 340 to process the signals to be visible and audible to the user, so it includes an audio decoder, a video decoder and a data decoder.

The IDE interface 370 receives a TP (Transport) data from the decoder 350, and transmits it to the HDD 380. If requested, the control unit 310 transmits the data recorded to the HDD 380 to the decoder 350.

The HDD 380 records the TP data transmitted from the IDE interface 370.

The output unit 360 outputs image data transmitted from the decoder 350.

The browsing controller 390 controls a trick play such as a skimming operation of a corresponding program by utilizing the scene information that is transmitted from the DeMux 340.

The browsing controller 390 also controls a skip operation of a program in correspondence to skip information inputted by the user's control.

In other words, to go to a specific address within a program during the skip or skimming operation, the browsing controller 390 controls the HDD upload unit 400 by using a start information of the scene information and a scene pointer information.

The HDD upload unit 400 is in charge of reading necessary information from the HDD 380.

Therefore, for the skip and skimming operations on a stored stream to be executed, the HDD upload unit 400 should read from the HDD 380 a corresponding data needed to go to the start point of the next scene.

That is to say, the browsing controller 390 uses a corresponding scene pointer and controls the HDD upload unit 400 to go to a proper position of the broadcast stream. In this manner, a trick play function on a scene basis is implemented.

FIG. 3b is a block diagram particularly illustrating a DeMux, a decoder, a browsing controller, and a HDD uproad control unit among the components of the PVR system shown in FIG. 3a.

As shown in FIG. 3b, a broadcast stream (video, audio, data) among broadcast information outputted from the DeMux 340 is inputted to the decoder 350, and the scene information is inputted to the browsing controller 390, to control the HDD upload controller 400 in response to a control signal.

The decoder 350 includes a video decoder 350a, an audio decoder 350b, and a data decoder 350c.

FIG. 4 illustrates a composition of broadcast information transporting a broadcast stream with a scene information according to a preferred embodiment of the present invention.

Referring to FIG. 4, the broadcast information consists of broadcast streams including a video, an audio, and a data signal, and a scene information.

The scene information can be included in the video signal or the data signal to be transported.

In the case that a program provider or a broadcast information provider (FIG. 2a, 230) directly transports scene information, audio and video signals of a program of interest and scene information thereof are multiplexed together before they are transported. Thus, there is no need to carry out a matching process separated from the corresponding program.

The scene information will be explained in more detail with reference to FIGS. 5a and 5b.

FIG. 5a illustrates a composition of a scene information according to a preferred embodiment of the present invention, in which a broadcast stream is transported with the scene information.

FIG. 5b illustrates a composition of a scene information according to a preferred embodiment of the present invention, in which a broadcast stream is not transported with the scene information.

Referring first to FIG. 5a, ‘scene info start code’ is an ID for distinguishing broadcast streams (video, audio, and additional information) and corresponding scene information within a transport stream packet composing a broadcast stream

That is, the scene info start code is an identifier informing that a certain data is the start of the scene information.

‘Scene pointer’ is a pointer pointing out a physical start point in a scene in a real broadcast program.

For example, if the user wants to replay a particular scene, he or she should know the accurate position of the scene within the stream

In effect, the user should know the accurate physical position of the video data of the corresponding scene. This can be accomplished by employing the scene pointer.

In other words, the scene pointer plays a key role for matching scene information with a real program.

Referring again to FIG. 5a, the scene information includes a scene info start code as an ID for informing that a corresponding data is the start of the scene information, a scene ID for identifying each scene, a scene pointer that corresponds to the start point of a corresponding scene, a skim info start code informing the start of skim information, and skim info.

Here, the scene info start code, the scene ID, and the scene pointer are key elements, while the skim info start code and the skim info are optional (indicated by*).

The scene pointer is a data for finding an accurate start point of a corresponding scene within a program For instance, the scene pointer can be a transport stream packet number corresponding to the start point of a present scene within a program.

The stream packet number is assigned in order of receiving. Therefore, the number ‘1’ is given to a first transport stream packet of the program.

In addition, the scene pointer can indicate a relative length from the start point of a preceding scene in a video frame unit, not in a transport stream packet.

The skim info indicates a time information for replaying each scene for implementation of a skim trick play.

Thus, the skim info includes a video frame or time information by the second.

Using this information, the PVR system replays each section only for a designated amount of time by the skim info.

If the skim info is omitted, the PVR system implements the skim function on the basis of a predetermined time value.

Refining next to FIG. 5b, the scene information includes a scene info start code as an ID for informing that a corresponding data is the start of the scene information; a program ID for matching a corresponding scene information with a program; a scene ID for identifying each scene, a scene pointer that corresponds to the start point of a corresponding scene, a skim info start code informing the start of skim information, skim info, and a scene info end code as an ID for informing the end of the scene information.

The broadcast display uses particularly the program ID among the scene information transported from the scene information service provider (FIG. 2b, 220) to identify with a broadcast stream transmitted from the station (FIG. 2b, 200). In this manner, a trick play can be implemented in each scene of a corresponding program.

Therefore, when the scene information is received, the broadcast display searches programs recorded to the HDD, and decides whether there exists a program that corresponds to the program ID of the scene information being received. If there is such program a process for identifying the scene information with the program is carried out.

In result, when the user replays a program, he or she can skip or skim scenes by utilizing the scene information being received later.

The following will now explain a preferred embodiment of a packet structure for the scene information shown in FIG. 5a/5b.

1) ‘Scene info start code’ has a size of 32 bits, and is defined to a hexadecimal 0×000001F0.

2) ‘Scene ID’ has a bit number proportional to a maximum number of scenes that can be provided in the system. In the present embodiment, the number of bits used for the scene ID is 8.

3) ‘Scene pointer’ is a physical start point of a present scene. Its unit is a relative length from the start point of a program expressed in terms of a number of transport packets. In the present embodiment, the scene pointer has a size of 64 bits.

4) ‘Skim info start code’ includes a corresponding ID in the scene information when ‘skim info’ is contained in the present scene information. It has a size of 32 bits, and defined to a hexadecimal 0×000001F1.

5) ‘Skim info’ indicates the length of time for skimming in a corresponding section. In the present embodiment, it means a number of 0.1-sec time units and has a size of 8 bits.

6) ‘Program ID’ has a fixed value that is stipulated in the standards for producing and transporting additional information about a program. Thus, the corresponding information is dependent on a broadcast system. In the present embodiment, it has a size of 32 bits.

Suppose that a following stream with the above-described packet structure s received from a station.

0×000001F0 03 0000000000000100 000001F1 IE (hexadecimal).

The above stream is a scene information corresponding to a third scene of a present program.

The start point of video data of the third scene is 0×100.

That is, it is located in the 256^{th} transport packet of the present program. Also, the replay time of each scene with the skimming function in process is 0×1E, i.e., 30*0.1=3 sec.

When the station transports the scene information for the scene No. 7 and the scene No. 8 at the same time, the information being transported looks like this:

0×000001F0 07 000000000006000 000001F1 1E 000001F0 08 0000000000A000 000001F1 14

Given that the skimming function is in process, the scene No. 7 is replayed for 3 seconds, and the scene No. 8 replayed for 2 seconds.

Meanwhile, suppose that the above information is transported by the third party service provider, and that the ID of the corresponding program is 0×00000FA, the third party service provider will transport a stream as follows:
0×000001F0 100000FA 03 000000000000100 000001F1 1E

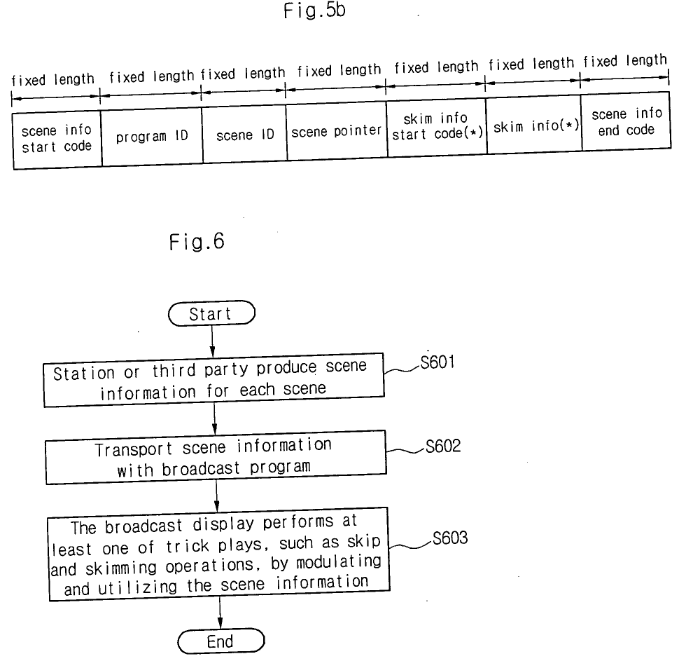

FIG. 6 is a flow chart describing a method for transporting scene information and a broadcast stream in real time or non-real time mode.

As explained with reference to FIG. 2b, a station or a third party service provider produces a scene information on each scene (S601).

The scene information and a broadcast stream are transported to a broadcast display in real time or non-real time mode (S602).

Upon receiving the scene information, the broadcast display performs at least one predetermined function, such as skip and skimming operations, by modulating and utilizing the scene information (S603).

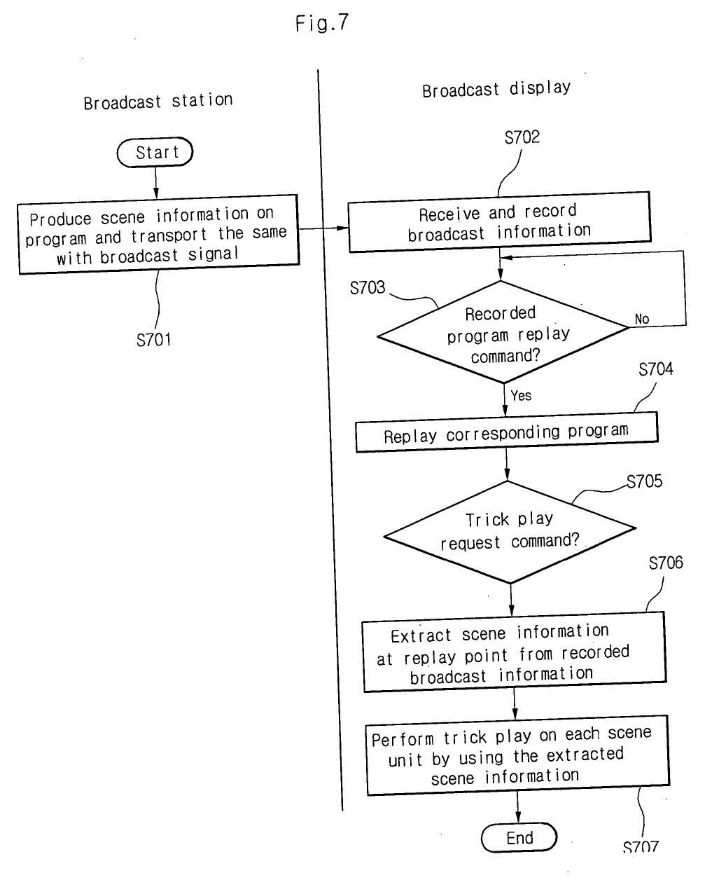

FIG. 7 is a flow chart describing a method for performing a trick play according to a preferred embodiment of the present invention.

Referring to FIG. 7 and FIG. 2, a station produces the scene information for each program, and transmits it with a broadcast stream to a broadcast display (S701).

The broadcast display records the broadcast information from the station (S702).

Then the broadcast display decides whether a recorded program replay command is sent from the user (S703).

If it turns out that the user sent the recorded program replay command, the broadcast display replays a corresponding program (S704).

Afterwards, the broadcast display decides whether the user sends a trick play request command (S705).

If the user issued the trick play request command, the broadcast display extracts the scene information at the replay point out of the recorded broadcast information (S706).

By using the extracted scene information, the broadcast display performs a trick play on each scene (S707).

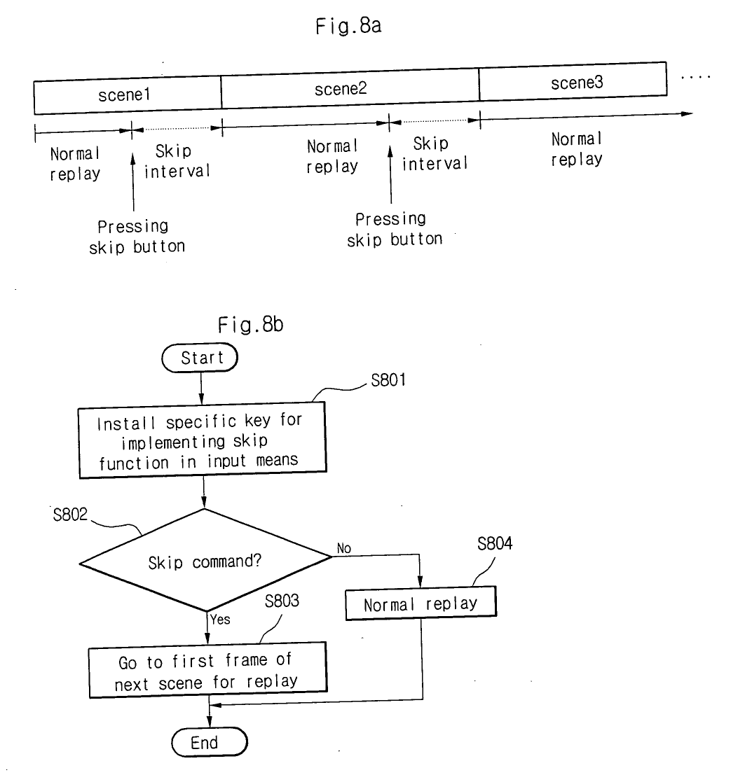

FIG. 8a is a schematic diagram illustrating implementation of the scene skip function according to a preferred embodiment of the present invention.

As shown in FIG. 8a, if a user inputs a skip command through a remote control while watching a recorded program, the broadcast display skips the scene currently being on (e.g., Scene No. 1) and goes to the first frame of the next scene (e.g., Scene No. 2) and replays the program.

The skip function can be conveniently used for time shift or replaying an already recorded program. For example, the user can skip the news to go to the next article (or story, or skip a scene in a drama to the next scene.

For example, suppose that the user is watching the scene No. 1 now, and then pressed the skip button. Then the scene No. 2 immediately goes to the first frame. In a similar manner, if the user presses the skip button while watching the scene No. 2, the scene No. 3 immediately goes to the first frame.

This service can be made possible simply by utilizing the scene pointer within the scene information that is transported by a station or a third party service provider.

That is, if the scene pointer is expressed in transport packet unit, as many scenes as the number of the corresponding packets are skipped. And, the control unit controls the HDD upload unit to read the recorded data that is located the corresponding packets away.

FIG. 8b is a flow chart describing a skip operation, one of predetermined functions by the user.

At first, a specific key for implementing the skip operation is included in an input means (S801).

It is checked whether a signal for skipping (that is, a skip command) is inputted during the replay of a program (S802).

If it turns out that the skip command is inputted, a next scene goes to the first frame and is replayed (S803).

If the skip command is not inputted, however, the replay operation is carried out as normal (S804).

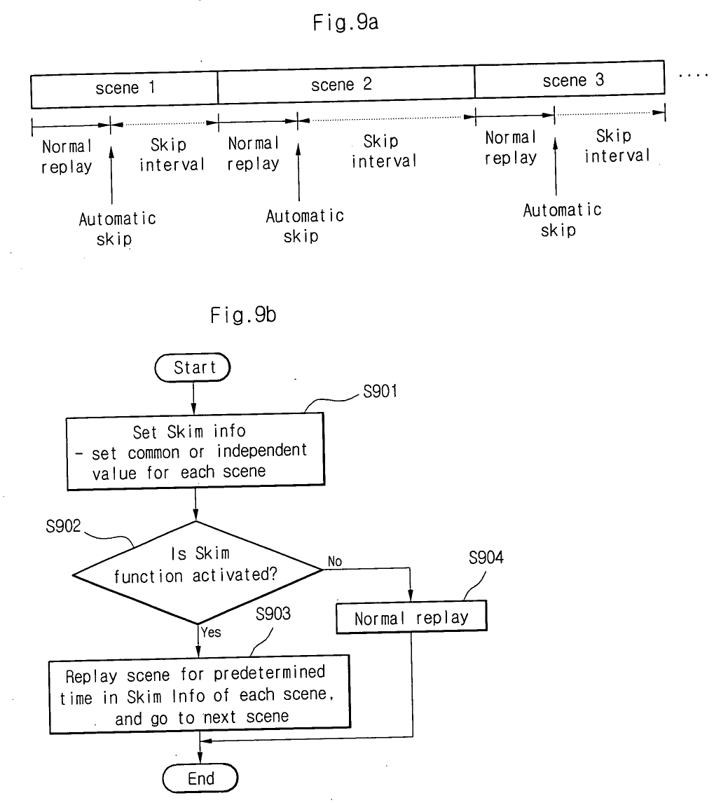

FIG. 9a is a schematic diagram illustrating implementation of a scene skim function according to a preferred embodiment of the present invention.

Referring to FIG. 5a and FIG. 9, in the case that the Skim info is included in the scene information, in other words, if the skimming function is activated, a broadcast display continues replaying each scene of a corresponding program for the designated time in the Skim info until a separate stop command (e.g., a stop button) is inputted by the user.

The length of time required for the normal replay operation is controlled, depending on the Skim info value for each scene.

For example, the n-th scene is replayed for the amount of time corresponding to the Skim info of the n-th scene (Scene 1), and then the n-th scene is skipped to the (n+1)th scene (Scene 2). In a similar way, the (n+1)th scene is replayed for the amount of time corresponding to the Skim info of the (n+1)th scene, and then the (n+1)th scene is skipped to the next scene such as (n+2) th scene (Scene 3).

If the Skim info is not provided by the station, the replay time of each scene can be controlled according to a predetermined value in the broadcast display.

This function is usually used to replay the starting part of each scene for a certain amount of time. Also, it can be used for a quick browsing or high light function of a program.

FIG. 9b is a flow chart describing a skim operation, one of the predetermined functions of a trick play by the user.

A station (FIG. 2b, 200) or a scene information service provider (FIG. 2b, 220) designates Skim info, and transmits it to a broadcast display (FIG. 2b, 210) (S910).

The Skim info for each scene can be made same or differently.

It is checked during the program replay whether the Skim info is contained in the scene information (S902).

If it turns out that the Skim info exists in the scene information, each scene is replayed based on the designated Skim info (S903).

On the other hand, if the Skim info is omitted, the replay operation is performed as normal (S904).

Therefore, the present invention provides the apparatus and method of broadcast service for enabling predetermined functions including a trick play by using the scene information that is transported with a broadcast stream in which the scene information about a broadcast program is produced by a broadcast information provider (e.g., a TV station/scene information service provider).

According to the present invention, the station or the third party service provider produces split scene information and transmits them in real time or non-real time mode. Then the broadcast display receives the scene information, and implements application services for a recorded broadcast program more effectively.

Moreover, according to the present invention, a program producer produces scene-related information for a trick play and transmits it to the broadcast display. In particular, the apparatus of the invention made it possible to simplify software and hardware system needed for splitting the recorded program into scenes, resultantly improving the operation speed and reducing the price burden.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. An apparatus of broadcast service for use in a broadcast system comprised of a broadcast information provider for outputting a broadcast stream and/or scene information; and a broadcast display for receiving and displaying the outputted broadcast stream, wherein when a broadcast stream including a plurality of scenes is transported to the broadcast display, the apparatus transports a scene information corresponding to each scene simultaneously with the broadcast stream or separately from the broadcast stream.

2. An apparatus of broadcast service, comprising:
a broadcast information provider for transporting scene information for at least one scene that composes the broadcast information; and
a broadcast display for recording and/or outputting the broadcast information transported from the broadcast information provider, and performing predetermined functions based on a user input command or the transported scene information.

3. The apparatus according to claim 2, wherein the broadcast information comprises a broadcast program that is transported in the format of broadcast streams including at least one of video, audio and data signals, and scene information.

4. The apparatus according to claim 3, wherein the scene information is included in the video signal or the data signal to be transported.

5. The apparatus according to claim 3, wherein the scene information comprises a scene info start code for identifying the scene information from broadcast stream among the transported broadcast information; a scene ID for distinguishing each scene; and a scene pointer for pointing out on which position of the transported broadcast stream a corresponding scene exist.

6. The apparatus according to claim 5, wherein the scene information further comprises Skim information for performing one of the predetermined functions.

7. The apparatus according to claim 6, wherein the Skim information comprises a skim info start code for informing the start of the Skim information, and skim info for providing a time information for performing the skim operation.

8. The apparatus according to claim 5, wherein the scene information that is transported without a broadcast stream in real time mode further comprises a program ID for matching the broadcast stream with the scene information at the broadcast display.

9. The apparatus according to claim 2, wherein the scene information provided from the broadcast information provider to the broadcast display is transported in real time or non-real time mode.

10. The apparatus according to claim 2, wherein a scene is controlled on the basis of a user input command or corresponding scene information of the broadcast information while the received broadcast information is recorded and/or outputted.

11. The apparatus according to claim 2, wherein the broadcast display replays a corresponding broadcast stream, and then performers a predetermined function play in the unit of scene, based on the user input command or the information included in the scene information.

12. The apparatus according to claim 2, wherein the broadcast display comprises:
a control unit for controlling the apparatus;
a tuner for receiving, under the control of the control unit, broadcast information of a channel;
a DeMux for parsing audio, video, data, and scene information in the broadcast information transported from the tuner,
a decoder for respectively decoding a broadcast stream including audio, video and data signals that are parsed by the DeMux;
a hard disk drive (HDD) for recording the decoded broadcast streams transported from the decoder,
a browsing controller for controlling predetermined functions for a corresponding broadcast stream by using the scene information that is transported from the DeMux; and
an upload controller for reading a broadcast stream from the HDD under the control of the browsing controller, to go to a specific position of a corresponding broadcast stream.

13. The apparatus according to claim 2, wherein a predetermined trick play function comprises at least one of skip, skimming, non-linear replay and high light.

14. A method of broadcast service, comprising the steps of:
producing a scene information on broadcast stream;
transporting to a broadcast display the scene information and a broadcast stream in real time or non-real time mode; and
based on the transported scene information, performing a predetermined function on the broadcast stream.

15. The method according to claim 14, wherein a plurality of scene information composing the broadcast stream are produced by a station that is a broadcast stream producer, and are outputted to the broadcast display in real time mode.

16. The method according to claim 14, wherein a plurality of scene information composing broadcast information are produced by a broadcast information provider, and are outputted to the broadcast display in real time or non-real time mode.

17. The method according to claim 14, wherein the predetermined function includes at least one of skip, skimming, non-linear replay and high light.

18. The method according to claim 17, wherein implementation of the skip function comprises the steps of:
installing a specific key for implementing the skip function in an input means;
checking whether a skip command is inputted; and
if the skip command is inputted, skipping a scene currently being replayed to go to the next scene, and outputting the same.

19. The method according to claim 17, wherein implementation of the skim function comprises the steps of:
setting a time for skimming;
checking whether the skim function is activated; and
if the skim function is activated, outputting a scene based on the skim information.

20. The method according to claim 18, wherein the time for skimming is set equally or differently per scene.

21. A method of broadcast service for enabling a trick play that is predetermined by a user based on a scene information produced by a broadcast information provider, the method comprising the steps of:
recording broadcast information transported from the broadcast information provider;
if a recorded program replay command is inputted by the user, extracting and replaying a corresponding program; and
if a trick play is requested on the basis of the user request or the scene information during the replay of the program, extracting from the recorded broadcast information a scene information at a replay point, or performing a trick play in the unit of scene using the same.

21. The method according to claim 20, wherein to move to a specific address within the program in the middle of skip or skimming operation among the predetermined trick play functions, controlling a HDD upload controller by using a scene info start code and a scene pointer.
